(19) United States
(12) Patent Application Publication
(10) Pub. No.: US 2006/0000295 A1
(43) Pub. Date: Jan. 5, 2006

(54) Apparatus for measuring glove fingertip integrity and method of using the same

(76) Inventors: Maris Vistins, Alpharetta, GA (US); Scott Stephen Englebert, Cumming, GA (US); David Wayne Johnson, Alpharetta, GA (US); Rodney S. McKee SR., Woodstock, GA (US)

Correspondence Address: KIMBERLY-CLARK WORLDWIDE, INC., 401 NORTH LAKE STREET, NEENAH, WI, 54956, US

(21) Appl. No.: 10/880,813

(22) Filed: Jun. 30, 2004

(51) Int. Cl. G01L 1/26

(52) U.S. Cl. 73/862.391

(57) ABSTRACT

The invention relates to an apparatus for measuring integrity of a fingertip of a polymeric glove. The apparatus contains a sample mount for holding the fingertip sample, a pressure supply and a pressure measuring device. The apparatus may be portable. The invention also relates to a method of measuring the integrity of a fingertip of a polymeric glove by mounting a sample on a testing apparatus, supplying pressure to the sample from an attached source and measuring the pressure required to burst the sample with a pressure measuring device. The invention also relates to a method of comparing the fingertip integrity of polymeric gloves among a set of polymeric gloves.

### BACKGROUND

Protective gloves are commonly used by medical personnel (such as doctors, nurses, dentists and emergency workers), food service personnel and many others, in order to protect themselves and others from contaminants and diseases such as hepatitis B and acquired immune deficiency syndrome (AIDS). Such gloves are expected to provide a barrier between the wearer and the environment that the glove comes in contact.

Unfortunately, there is a risk of damage to the glove during wear. Glove failure may be caused by external sources, such as the use of sharp instruments (e.g., needles and scalpels) or even by an internal source, such as a wearer's long fingernails. The type of glove also is a factor of glove failure. Independent studies have shown that vinyl examination gloves have a higher failure rate than that observed with latex gloves. (See Kerr, L. N. et al., “The Effect of Simulated Clinical Use on Vinyl and Latex Exam Glove Durability,” Journal of Testing and Evaluation, Vol. 30, No. 5, pp. 415-420 (2002); and Korniewicz, D. M. et al., “Performance of latex and nonlatex medical examination gloves during simulated use,” American Journal of Infection Control, Vol. 30, No. 2, pp. 133-138 (2002)).

Clinical observation of failure in vinyl gloves has also shown that a majority of failures occur in the fingers or thumb of the glove and, more particularly, at the fingertips of the gloves. This is not particularly surprising as the fingertips of vinyl gloves are generally thinner/weaker than the rest of the glove in large part due to the manufacturing process of such gloves.

Vinyl gloves, such as the glove depicted in FIG. 1, are formed on hand-shaped formers which are dipped into a polymer bath, removed from the bath, and then heated in an oven. The polymer continues to flow on the former until it is heated in the oven. Thus, the hand-shaped formers are rotated about its central axis (marked as X on FIG. 1) which is kept parallel to the ground. This keeps the polymer on the former until the former can reach the oven. If the former was held perpendicular to the ground, the polymer would flow off the former fingertips. While this manipulation of the former provides the majority of the formed glove with adequate polymer coverage, there is less coverage on the fingertips of the glove.

Improvements in polymers and processes are ongoing, but there has been a deficiency in testing methodologies to show whether improvements have been made as to fingertip durability. The thickness of the glove at the fingertips can be measured, but the thickness measurement, by itself, does not fully capture improvements to the strength of the base polymer(s) being used.

Another test commonly performed on such gloves is ASTM F1306-90, entitled “Slow Rate Penetration Resistance of Flexible Barrier Films and Laminates.” In general, this test measures the puncture resistance of the specimen by clamping the sample in a universal tester and driving a probe into the contact with the sample at a fixed speed until the sample perforates. However, this test method and corresponding apparatus requires a specimen that is 76 mm by 75 mm. Thus, the only part of a typical glove that can be tested is the palm or back of the glove, rather than the fingers.

Air burst testing is also commonly performed on condoms (see ASTM D3492-03, “Standard Specification for Rubber Contraceptives (Male Condoms)”). In the air burst testing, the sample is placed on the apparatus where it is filled with air until it bursts. Air pressure and volume are recorded at the moment of burst. However, when gloves are tested by this type of method, the increasing air pressure expands the glove in the palm rather than the entire glove uniformly. The fingers do not expand along with the palm and the glove generally ruptures in the palm or at the finger/palm transition of the glove before the fingers will expand to any degree. Therefore, the test does not provide an adequate understanding of the durability of the glove fingertips.

A test and corresponding testing apparatus is desired to better evaluate the integrity of the fingertips of gloves. It is also desired that such a test could compare gloves of the same type and be able to demonstrate improvements made to fingertip integrity. It is also desired to have an easily portable version of such a test apparatus to evaluate or demonstrate fingertip integrity wherever it is desired to make such an evaluation or demonstration.

### SUMMARY OF THE INVENTION

The present invention is directed to an apparatus for measuring the integrity of a glove fingertip and has a sample mount to hold the test sample, a pressure supply and a pressure measuring device. The apparatus forms a closed system between the pressure supply, pressure measuring device and sample mount with sample, when the sample is placed on the sample mount. In one embodiment, the invention is portable.

The invention also provides a method for measuring the integrity of a glove fingertip using the inventive testing apparatus. The test method includes the steps of providing a test sample; mounting the sample on the testing apparatus; initializing the pressure measuring device; providing pressure to the sample from the pressure supply; and acquiring data from the measuring device relating to the pressure required to rupture the sample. In one embodiment, this data is acquired and recorded graphically or pictorially. In a further embodiment, this graphic or picture is conveyed on a computer, television or paper.

Finally, the invention also provides a method of comparing glove fingertip integrity among a set of gloves using the inventive testing apparatus. The test method includes the steps of providing a test sample; mounting the sample on the testing apparatus; initializing the pressure measuring device; providing pressure to the sample from the pressure supply; measuring or observing the pressure required to rupture the sample; repeating the tests on other samples; and comparing the measurements or observations of the samples. In one embodiment, the measurement or observation is recorded graphically or pictorially. In a further embodiment, this graphic or picture is conveyed on a computer, television or paper.

In another embodiment, the comparison of the samples is presented graphically or pictorially. In a further embodiment, the graphic or picture is conveyed on a computer, television or paper.

### BRIEF DESCRIPTION OF THE DRAWINGS

FIG. 1A is a perspective view of a protective glove which may be tested by the method of this invention.

FIG. 1B is a perspective view of a fingertip sample cut from the sample glove of FIG. 1A along the segment Y-Y′.

FIG. 2 is a schematic representation of the apparatus of this invention

FIG. 3 is a schematic illustration of portable version of the apparatus of the present invention.

FIG. 4A is a cross-sectional side of the base assembly of the apparatus of FIG. 3 with the sample collar removed for loading of a test sample.

FIG. 4B is a cross-sectional end view of the base assembly of the apparatus of FIG. 3 with the sample and collar in position ready for testing.

### DETAILED DESCRIPTION

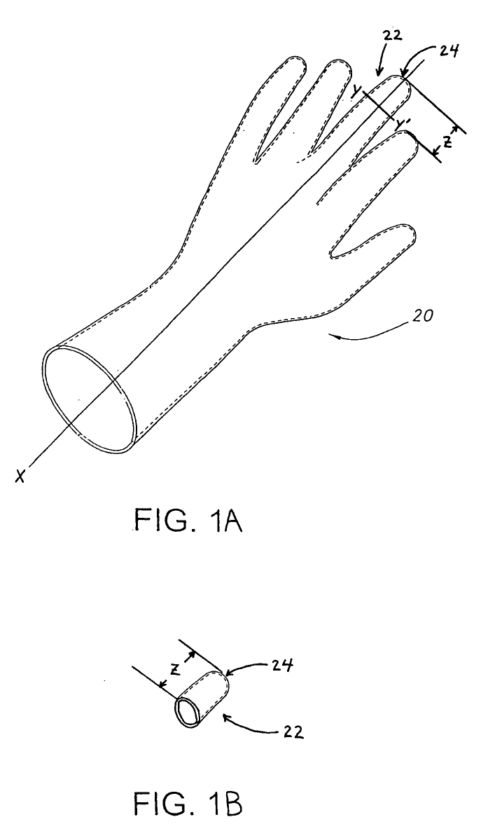

The present invention related to an apparatus and a method of using the apparatus to test and compare the fingertip integrity of polymeric gloves, such as the one illustrated in FIG. 1A. The test method and apparatus tests the integrity of an individual fingertip of a glove (as shown in FIG. 1B) by measuring the pressure necessary to burst the fingertip sample 22. While the description of the invention focuses on the testing of the integrity of the fingertip of a polymeric glove, the same test could be preformed to determine the integrity of any small area of such gloves.

The “fingertips” of a glove, as the term is used herein, refers the distal ends of the appendages of the glove. As shown in FIGS. 1A and 1B, the fingertip 22 has a length Z and a diameter. The actual dimensions of fingertips will vary as the variety of glove sizes is numerous. However, the fingertip length is typically in the range of 5 mm to 50 mm and the diameter is typically in the range of 5 mm to 40 mm.

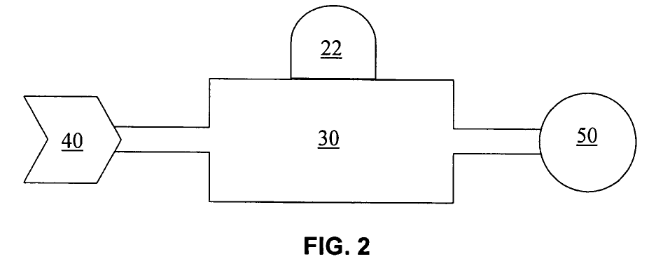

The apparatus of the invention is schematically represented in FIG. 2. The basic structure of the testing apparatus is a sample mount 30, a pressure source 40 and a pressure measuring device 50. The pieces are configured such that a closed system is formed between the sample 22 on the sample mount 30, the pressure source 40 and the pressure measuring device 50. The term “closed system” is used here to indicate that once the sample 22 is secured on the sample mount 30, the only exterior input to the interior of the sample 22 will be pressure supplied from the pressure supply 40. As such, the pressure measuring device 50 will be able to measure the pressure in the closed system until the test is concluded when the sample 22 is ruptured.

The sample mount 30 holds the sample in place during testing and ensures that all of the pressure applied to the closed system by the pressure source 40 is delivered to the sample 22. The mount 30 should be suitable for holding on to the sample 22 while under pressure as well as providing a seal so that no pressure can escape the closed system until the sample 22 is ruptured. The mount 30 should be sized to accommodate the fingertip sample 22 from a glove 20. The mount 30 cannot be so large that it stretches the sample, nor can it be so small that good seal cannot be maintained between the sample 22 and the closed system. It may be necessary to have different sized mounts 30 to accommodate different sizes of gloves. Alternatively, the mount 30 may be designed to adapt to or to accommodate different sized samples.

The pressure supply 40 should supply pressure to the closed system of the including the sample 22. The rate of pressure supplied to the system may be controllable and monitored by the pressure supply 40. Pressure can be supplied in the form of any medium that is compatible with the sample and apparatus. The medium should not react with the sample, be able to pass through the sample, nor should it be able to compromise the sample other than by rupturing the sample through application of pressure. Preferably, the pressure supply 40 would be an air supply; however, any gas compatible with the sample material could be used. Alternatively, a liquid, such as water, could be used.

The pressure measuring device 50 is capable of measuring the pressure of the closed system during the test procedure. The measuring device 50 needs to be compatible with the medium used to apply pressure to the sample and needs to appropriately rated for the pressures that will be encountered in conducting the tests. For example, in the testing of vinyl glove fingertips by applying pressurized air to the sample, an air pressure gauge rated from 0 to 60 psi adequately covers the range of burst pressures encountered.

It is additionally helpful for the pressure gauge be capable of holding the highest pressure encountered to get a more accurate understanding of the burst pressure. Such a pressure gauge would need to be reset or initialized before each sample is tested. Alternatively, the pressure could be constantly monitored electronically by a computer program which would then report the peak pressure encountered (i.e., the burst pressure). Other methods which observe or record the burst pressure are considered to be within the scope of the invention.

The test procedure using the apparatus involves preparing the sample 22, mounting the sample 22 on the sample mount 30, initializing the pressure measuring device 50, applying pressure from the pressure supply 40, and observing and recording the pressure at which the sample 22 is ruptured. The test would be repeated, with new samples, as many times as required to obtain a representative sample set.

The sample 22 is prepared by cutting the sample 22 from the rest of the glove 20. In preparing samples for a sample set, one should keep in mind that each finger of the glove may have a slightly different size and come from a relatively different position on a former. It is preferred that all the samples for a single sample set be made up of the same finger from multiple gloves. Additional sample sets may be made up of other fingers (or thumbs). Alternatively, if the sample mount 30 can adequately accommodate the range of fingertip sizes for a particular sized glove, a sample may be made up of all the fingers of a single glove. In such an instance where all the fingers are used, an average value may be calculated for the entire glove.

It is also important to remember that the sample 22 should be cut consistently to the same distance from tip 24 of the finger. On FIG. 1A, that length is represented as length Z, as shown for the middle finger of the glove. The length Z of the sample 22 is dependent on the design of the mount 30. The use of a shorter length Z focuses the test on the area of interest, namely the fingertip 22. Longer lengths will incorporate more of the finger strength along with the fingertip 22.

The sample 22, once prepared is carefully placed and secured on the sample mount 30 such that the sample 22 is not unduly stretched or damaged prior to testing. The pressure measuring device 50 is initialized and pressure is delivered by the pressure supply 40. The pressure at which the sample 22 ruptures is observed and recorded as the burst pressure.

Another consideration with this test method is the type of glove substrate being tested. Gloves of like materials should be tested and compared. The test will likely produce incompatible data if different types of gloves are tested. For example, a latex glove has much more elasticity than that of a vinyl glove and will tend to inflate more than a vinyl glove will prior to the glove bursting. Thus, data taken for a vinyl glove sample may not be directly comparable with that obtained for a latex glove sample. However, data for a latex glove sample should be comparable with another latex glove sample and a vinyl glove sample should be comparable with another vinyl glove sample.

As discussed above with regard to the pressure measuring device 50, the burst pressure can be observed visually as the test is conducted, may be observed from the measuring device that holds the maximum pressure, or may be recorded through a computer program. Such data could be recorded in tabular, pictorially or graphical form, or any way that conveys the test results. The table, picture or graph could then be displayed on a computer screen, conveyed on a television screen, printed on paper or conveyed in such a way to communicate the results to others.

In the same way, a sample sets of current products and sets of products with fingertip improvements, or sets of products from another manufacturer, could be tested and the results compared. Again the data could be recorded in tabular, pictorially or graphical form, or any way that conveys the test results. The table, picture or graph could then be displayed on a computer screen, conveyed on a television screen, printed on paper or conveyed in such a way to communicate to others the results and differences between the sample sets and educate such persons about the integrity of the glove fingertips.

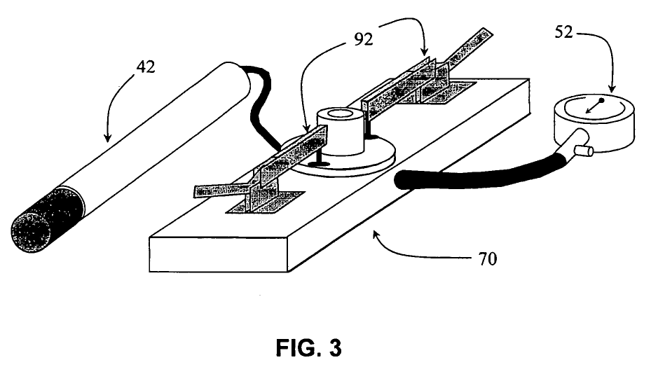

In one embodiment of the invention a portable version of the testing apparatus was developed and is illustrated in FIG. 3. Such a portable apparatus may be useful for demonstrating improvements to glove fingertip integrity or comparing fingertip integrity of various gloves, wherever such a demonstration is desired. For example, such an apparatus may be helpful to test gloves near the glove manufacturing equipment. Alternatively, such a portable testing apparatus could be used by marketing personnel to compare products for consumers at a location convenient to the consumer. The apparatus is small enough to be easily portable to any desired location. Additionally, to ensure that the apparatus could be used anywhere, the apparatus was designed to be self contained; no additional equipment or specific location is required to use the testing apparatus. The apparatus also needed to be simple enough for anyone to operate and economical in its construction.

As can be seen in FIG. 3, the portable apparatus is made up of a sample mount assembly 70, a pocket-sized air pump 42 connected to the sample mount assembly 70, and an air pressure gauge 52, also attached to the sample mount assembly 70 and on the opposite side of the sample mount assembly 70 from the air pump 42. The air pump 42 and the pressure gauge 52 are connected to the sample mount assembly 70 by flexible tubing secured by air-tight fittings. To protect and aid in transport of the apparatus, the sample mount assembly 70 was mounted on the inside lid of a plastic snap-case with an interior volume of 5.7 L (not shown). The actual case used can be obtained from the Rubbermaid Corporation, Wooster, Ohio, Model No. 2281. The lid of the snap case acts as the platform for the testing apparatus. The body of the plastic case folds over the apparatus and is secured to the lid/testing platform for transport and storage. The body can be folded back for loading of samples and can remain open, or can be partially closed, during the test procedure. Keeping the lid partially closed during testing helps dampen the noise associated with the rupturing of the sample and provides an added safety factor with regard to sample failure. Including the case in which it is enclosed, the testing apparatus is approximately 360 mm by 200 mm by 120 mm or less than 9000 cm³. While an apparatus of this size has been found to be conveniently portable, other sized apparatus and cases containing such apparatus which are capable of being transported are contemplated and considered within the scope of the invention.

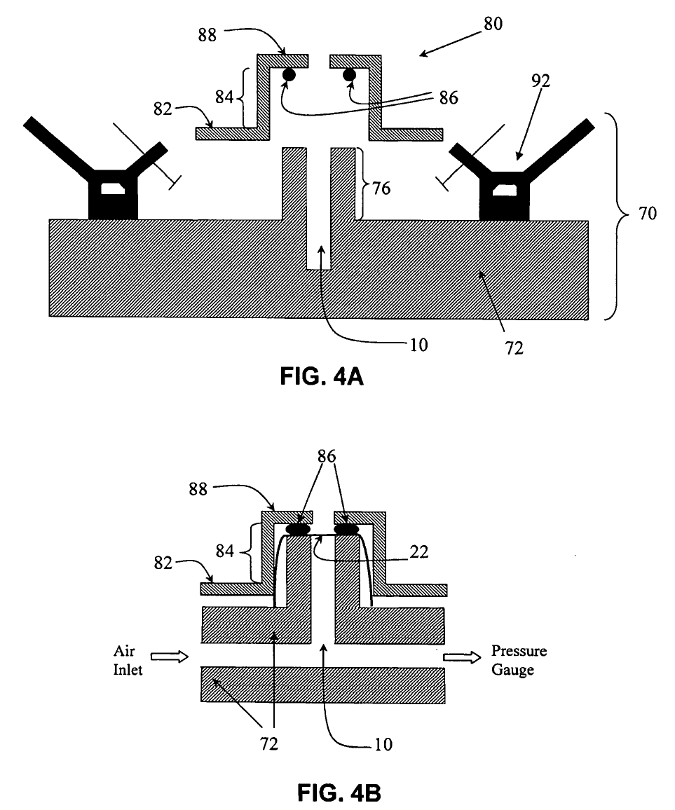

FIGS. 4A and 4B show cross-sectional views of the sample mount assembly 70. The assembly 70 is made up of the combination of the base 72 which is connected to the air pump 42 and pressure gauge 52; the neck 76 which protrudes from the base 72; and the sample collar 80 which secures the sample 22 to the base during testing.

The base 72 and sample collar 80 are made of a hard polymeric material and could be made of any rigid material compatible with the pressure medium being used. The base 72 is machined to provide an air channel 10 between the air pump 42, the pressure gauge 52 and up the neck 76. The base 72 is approximately 125 mm by 52 mm and stands about 25 mm tall. The neck 76 is cylindrical in shape and protrudes approximately 25 mm from the upper surface of the base 72. The neck 76 has an outside diameter of about 17 mm and inside diameter of about 10 mm. In testing, the fingertip sample 22 is placed over the neck 76. The neck 76 is sized to accept a middle or index fingertip of a medium sized glove where the sample length Z is 25 mm (1 inch).

The sample collar 80 fits over the neck 76 while a sample 22 is on the neck 76. The sample collar 80 is “top hat” shaped, with a brim 82, a jacket 84 rising from the brim 82, and a cap section 88. The collar 80 is machined such that the jacket 84 and brim 82 fits down over the sample 22 on the neck 76, with enough clearance so that the sample 22 is not stretched or damaged. The interior diameter of the jacket 84 is about 18 mm.

The interior surface of the cap 88 rests on top of the top surface of the neck 76 during testing. An opening of about 12 mm in diameter is present in the cap 88 to allow the sample to expand in response to the application of pressure and allows the air to escape once the sample 22 is ruptured.

A sealing gasket 86 is present at the top of the jacket 84, where the jacket 84 meets the cap 88. The sealing gasket 86 forms a seal between the cap 88, sample 22 and neck 76 during testing so that all of the air pressure supplied during testing will act on the sample 22 rather than escaping the closed system. The seal is formed by the compression of the sealing gasket 86 against the sample 22 and neck 76 when the collar 80 is clamped by a set of clamps 92, engaged against the top surface of the brim 82. The brim 82 is approximately 51 mm in diameter where the top surface of the brim 82 extends radially from the outside of the jacket 84 about 12 mm. The clamps 92 are mounted on the base 72 and are engaged against the brim 82. Base-mounted, hand toggle clamps, such as the KNU-VISE H-100 clamps which can be obtained from Lapeer Manufacturing Company, Lapper, Mich., were used in the construction of the portable apparatus.

The pocket-sized air pump 42, can be any small hand-operated air pump such as can be obtained from any athletic supply store or bike shop. The pump 42 used for the apparatus is about 25 cm in length and 2.5 cm in diameter. The pressure gauge 52 used in the apparatus provides readings between 0 and 60 psi and has a stop hand that holds and shows the maximum pressure reached until the reset valve is depressed. Such a pressure gauge such as available from the McMaster-Carr Supply Company, Chicago, Ill., Model 6654A11.

### EXAMPLE

A series of tests were conducted with the apparatus shown in FIG. 3 and as previously described. Sample sets of eight different vinyl exam gloves from various manufacturers were prepared and tested. Each sample set consisted of five samples. The burst pressure was recorded for each sample and an average burst pressure was calculated for each sample set. The data from these tests have been compiled in Table 1 below.

Codes 1 through 6 are sample sets of vinyl exam gloves available from a variety of manufacturers. All of the codes are readily available from any medical supply company. Code 1 were Maxxim SensiCare® Exam gloves available from Maxxim Medical, Clearwater, Fla. Code 2 were MediGuard® vinyl exam gloves available from Medline Industries, Inc., Mundelein, Ill. Code 3 were Cypress Synthesis® vinyl exam gloves available from Cypress Medical Products, LP, McHenry, Ill. Code 4 were Allegiance InstaGard® Synthetic exam gloves and Code 5 were Allegiance Esteem® Stretchy Synthetic exam gloves, both available from CardinalHealth, McGaw Park, Ill. Code 6 were Sempermed SemperCare™ vinyl exam gloves, available from Sempermed USA Inc., Clearwater, Fla. Code 7 were SAFESKIN® SYNTHETIC Powder-Free Vinyl exam gloves, available from Kimberly-Clark Corporation, Roswell, Ga. Code 8 is an improved version of Code 7. All values given in Table 1 are in units of pressure per square inch (psi).

TABLE 1

| | Code | Code | Code | Code | Code | Code | Code | Code |
|---|---|---|---|---|---|---|---|---|
| | 1 | 2 | 3 | 4 | 5 | 6 | 7 | 8 |
| 1 | 16 | 16 | 18 | 18 | 15 | 15 | 15 | 34 |
| 2 | 15 | 14 | 18 | 17 | 11 | 14 | 14 | 27 |
| 3 | 13 | 18 | 18 | 18 | 13 | 20 | 20 | 33 |
| 4 | 14 | 17 | 16 | 18 | 13 | 18 | 18 | 36 |
| 5 | 14 | 19 | 18 | 17 | 14 | 18 | 18 | 33 |
| Avg. | 14.4 | 16.8 | 17.6 | 17.6 | 13.2 | 17 | 17 | 32.6 |

As can be seen by the data in Table 1, the failure of commercially available vinyl exam gloves ranged from burst pressures of 13.2 to 17.6 psi. The test demonstrated an improved fingertip durability of Code 8 over Code 7; an improvement of about 92%.

The foregoing description is intended as illustrative and is not to be taken as limiting. Still other variations are possible without departing from the spirit and scope of this invention and will readily present themselves to one skilled in the art.

We claim:

1. An apparatus for measuring the integrity of a fingertip of a polymeric glove, comprising:
a sample mount adapted to hold a fingertip test sample;
a pressure supply attached to the mount; and
a pressure measuring device attached to the mount,
where when a test sample is held in the sample mount, a closed system is present within the apparatus
and where the pressure supply is capable of increasing the pressure of the closed system until the test sample is ruptured
and where the pressure measuring device is capable of reporting the pressure of the closed system.

2. The apparatus of claim 1, where the apparatus is portable.

3. The apparatus of claim 2, where the apparatus has a total volume of 9000 cubic centimeters or smaller.

4. The apparatus of claim 2, where the pressure supply is a pocket-sized, hand-operated air pump.

5. The apparatus of claim 1, where the pressure measuring device is capable of recording the pressure of the closed system.

6. A method of measuring fingertip integrity of a polymeric glove, comprising the steps of:
providing a testing apparatus having a sample mount adapted to hold a fingertip test sample, a pressure supply, and a pressure measuring device, wherein a closed system is present within the apparatus when a test sample is held by the sample mount;
mounting a fingertip test sample on the testing apparatus;
initializing the pressure measuring device;
providing pressure to the test sample form the pressure supply; and
acquiring data from the measuring device relating to the pressure required to rupture the fingertip test sample.

7. The method of claim 6, wherein the data is acquired and recorded graphically or pictorially.

8. The method of claim 7, wherein the graphic or picture is conveyed on a computer, television or paper.

9. A method of comparing the fingertip integrity of polymeric gloves among a set of polymeric gloves, comprising the steps of:
providing a testing apparatus having a sample mount adapted to hold a test sample, a pressure supply, and a pressure measuring device, wherein a closed system is present within the apparatus when a test sample is held by the sample mount;
mounting a fingertip test sample on the testing apparatus;
initializing the pressure measuring device;
providing pressure to the test sample form the pressure supply;
measuring or observing the pressure required to rupture the test sample;
repeating the previous steps with an alternate sample; and
comparing the measurements or observations of the samples.

10. The method of claim 9, wherein the measurement or observation of the pressure required to rupture the test sample is acquired and recorded graphically or pictorially.

11. The method of claim 10, wherein the graphic or picture is conveyed on a computer, television or paper.

12. The method of claim 9, wherein the comparison of samples is presented graphically or pictorially.

13. The method of claim 12, wherein the graphic or picture is conveyed on a computer, television or paper.
